(19) United States
(12) Patent Application Publication
(10) Pub. No.: US 2022/0300712 A1
(43) Pub. Date: Sep. 22, 2022

(54) ARTIFICIAL INTELLIGENCE-BASED QUESTION-ANSWER NATURAL LANGUAGE PROCESSING TRACES

(71) Applicant: HEWLETT PACKARD ENTERPRISE DEVELOPMENT LP, Houston, TX (US)

(72) Inventors: Suparna BHATTACHARYA, Bangalore (IN); Mayukh DUTTA, Bangalore (IN); Manoj SRIVATSAV, Bangalore (IN); Sergey SEREBRYAKOV, Milpitas, CA (US)

(21) Appl. No.: 17/209,174

(22) Filed: Mar. 22, 2021

(51) Int. Cl. G06F 40/30; G06N 5/04; G06N 20/00; G06F 40/295; G06T 11/20

(52) U.S. Cl. CPC G06F 40/30; G06N 5/04; G06N 20/00; G06F 40/295; G06T 11/206

(57) ABSTRACT

Artificial-intelligence (AI)-based question-answer (QA) trace analysis of a text corpus that identifies answers to a natural language question and assesses the manner in which those answers evolve over time based on associated context is described herein. A set of QA trace records can be generated that includes a collection of answers derived from a text corpus in response to a posed natural language question along with contextual information relating to the answers. The set of QA trace records can be ordered based on corresponding date attributes gleaned from the contextual information to produce a time-series of QA trace records that can be processed by various types of downstream processing. Such downstream processing can include data visualization, pattern recognition, or the like for assessing how an answer to a natural language question evolves over time, identifying patterns/trends that develop over time with respect to the set of answers, and so forth.

### DESCRIPTION OF RELATED ART

Question-answer (QA) systems are configured to automatically answer natural language questions. QA systems generally include an information retrieval (IR) component and a natural language processing (NLP) component. The IR component may be configured to obtain information technology (IT) resources that are relevant to an information need from a collection of those resources. The NLP component may be configured to perform NLP processing on an input natural language question as well as on the information resources retrieved by the IR component. Such NLP processing may include, for example, text and speech processing, morphological analysis, syntactic analysis, semantic analysis, and so forth.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example flowchart illustrating a question-answer (QA) trace record generation process according to example embodiments of the invention.

FIG. 2 depicts example processing modules of a QA trace engine according to example embodiments of the invention.

FIG. 3 depicts an example QA trace record according to example embodiments of the invention.

FIG. 4 depicts a set of executable instructions stored in machine-readable storage media that, when executed, cause an illustrative method to be performed for generating QA trace records based on various stages of processing performed on an input dataset according to example embodiments of the invention.

FIGS. 5A and 5B depict example visualization plots according to example embodiments of the invention.

FIG. 6 is an example computing component that may be used to implement various features of example embodiments of the invention.

The figures are not exhaustive and do not limit the present disclosure to the precise form disclosed.

### DETAILED DESCRIPTION

Example embodiments of the invention relate to, among other things, systems, methods, computer-readable media, techniques, and methodologies for performing an artificial-intelligence (AI)-based question-answer (QA) trace analysis of a text corpus to identify and analyze answers to a natural language question and assess the manner in which those answers evolve over time based on associated context. In example embodiments, a time-series of QA trace records may be generated that indicate a collection of answers to a natural language question and associated contextual information. The time-series of QA trace records can be analyzed/manipulated/interpreted in connection with a variety of types of downstream processing to, for example, assess how an answer to a natural language question evolves over time, identify patterns/trends that develop over time with respect to the set of answers, and the like.

Traditionally, search engines and QA systems are geared towards locating, navigating, and ranking top answers/matches. A list of ranked answers, however, does not provide insight into patterns/trends in the answers over time. This is especially true in fields where the knowledge base is evolving rapidly such as in the case of scientific literature relating to a new and not yet well-understood disease. More specifically, while domain-specific tuning of QA systems and search engines for scientific literature has been researched in the past, conventional solutions are unable to address a number of technical challenges relating to scientific literature review, particularly as it relates to a new disease having a fast-paced temporal and spatial impact on a global scale, for example.

For instance, conventional solutions lack the capability to keep pace with the rapidly evolving knowledge/findings relating to a new disease; lack the capability to filter out questionable data/findings especially when the number of hypotheses/studies is rapidly growing and most such studies are not peer-reviewed; and so forth. Often, such conventional solutions draw conclusions based on easily accessible slices of data, which may not be generalizable or which may evolve over time and weaken the initial conclusions that are drawn. Furthermore, in the case of an emerging disease having a global impact, there is a need to quickly “connect the dots” across different research areas, with each such research area requiring highly specialized domain expertise. Conventional QA solutions are also incapable of addressing this technical challenge. Moreover, while there exist some concept analysis tools and/or topic modeling techniques available to explore/discover co-relationships within a text corpus, the results they produce tend to be coarse-grained and in need of substantial curation.

Example embodiments of the invention provide a technical solution to the above-described technical problems associated with conventional tools/techniques for analyzing a text corpus such as a specialized, domain-specific text corpus of scientific literature. A text corpus is a language resource that may include any collection of text, graphics, or the like, in one or more languages. A text corpus may include structured and/or unstructured text. A variety of types of processing can be performed on a text corpus including, for example, natural language processing, computational linguistic processing, machine translation, or the like. In some cases, a text corpus may be annotated to facilitate further downstream processing such as natural language processing. An example of annotation is part-of-speech (POS) tagging, according to which information about each word's part of speech is added to the text corpus in the form of tags.

Example embodiments of the invention provide a technical solution to the above-described technical problems in the form of a series of QA trace records generated over time, where each QA trace record provides a snapshot of the context surrounding an answer at a given point in time, and where the series of QA trace records ordered over time reveals patterns/trends in the evolution of the answers and the corresponding contextual information over time. A QA trace record may include, for example, one or more answers to a natural language question that are extracted from a text corpus in relation to a particular snapshot in time and contextual information corresponding to the answers at that snapshot in time. The snapshot in time may be a configurable span of time over which a corresponding portion of the text corpus is assessed to identify and extract answers to a natural language question and associated contextual information. In the case of a scientific literature text corpus, for instance, the period of time to which a particular QA trace record corresponds may be a date range, such that the portion of the text corpus from which answer(s) and contextual information are extracted for populating the QA trace record includes any published studies, articles, etc. that have an associated date (e.g., a date of the medical study/clinical trial that was performed, a date that the study/article was published, etc.) that falls within the date range.

More specifically, by extracting contextual information from a text corpus over a period of time along with corresponding answers to a natural language question that is posed against the text corpus, and then generating a time-series of QA trace records containing the extracted answers and contextual information, example embodiments of the invention provide the capability to assess, over time, the evolution of the body of knowledge represented by the text corpus, thereby identifying patterns/trends in that evolution and ultimately arriving at a more refined understanding of the text corpus, from which more nuanced insights can be made. It should be appreciated that while the term text corpus is used herein for ease of explanation, the dataset against which natural language questions may be posed to generate the QA trace records may include any type of structured or unstructured information including, without limitation, textual data, graphical data, image data, tabular data, or the like.

According to example embodiments of the invention, a set of QA trace records may be generated over a period of time. Each QA trace record may include an answer identified in response to a posed natural language question and contextual information associated with the identified answer. The contextual information in each QA trace record may include various attribute information relating to the corresponding answer including, for example, a date attribute identifying a time period to which the answer is contextually linked, a domain-specific attribute (e.g., a particular study methodology chosen for a scientific study), and so forth.

In example embodiments, natural language processing (NLP) is first performed on the posed question and the text corpus to extract a set of answers determined to be relevant to the posed question. A QA system pipeline that combines, for example, information retrieval and neural language models may be used to extract the set of answers. The information retrieval and neural language models may include large transformer-based architectures such as bidirectional encoder representation (BERT) models. In example embodiments, a scope adjustment mechanism is provided to maximize the number of answers and context passage occurrences found. For instance, while the initial scope of documents searched may be filtered/contracted to those documents deemed relevant to a broad topic to which the posed natural language question relates (e.g., an emerging disease in humans), and ultimately to passages that are relevant to the posed question, the scope may subsequently be expanded to more passages on related material (e.g., other passages in a same technical paper or related concepts) in order to gather additional context and generate additional QA trace records.

Once a set of answers relevant to a posed natural language question are extracted, additional QA processing may be performed on the extracted passages to determine contextual information relating to the extracted answers. For instance, one or more additional questions may be posed that relate to specific details associated with an answer. Example questions include “what was the clinical study method that was used?” (e.g., a double-blind controlled study) or “where were the patients from?” (e.g., what geographical region(s) did the patients reside in). Answers to these additional, answer-specific questions may then form at least part of the contextual information used to generate the QA trace records. The set of candidate answers to these additional, more specific questions that may be posed against the text corpus may have a narrower scope than the set of candidate answers to the original natural language question. For example, a question that focuses on the type of clinical study that was performed would generate a set of candidate answers that is more focused and narrower in scope than a more general question such as “what are the most common symptoms for disease X?”

In addition, domain-specific named entity recognition (NER), relationship extraction processing, and/or event extraction processing may be performed on the extracted passages to mine domain-specific concepts from the passages for inclusion as at least a portion of the contextual information in QA trace records. As an illustrative example, in the case of a scientific literature corpus and QA processing relating to a particular disease being studied, the NER processing may utilize various scientific biomedical entity recognition models that search the extracted passages for particular disease terms, chemical terms, gene terms, organ names, or the like. As another non-limiting example, a clinical context recognition model such as a PICO (participant, intervention, comparison, outcome) model may be employed.

In example embodiments, the extracted answers and the corresponding contextual information may exhibit a significant amount of variation in wording. For instance, certain answers and/or contextual information may utilize varied phraseology, but may actually convey the same or similar meaning. As such, in some example embodiments, post-processing such as distillation and aggregation may be performed to prioritize more relevant context prior to generating and populating the QA trace records. In example embodiments, a series of QA trace records organized chronologically may be generated and populated with the extracted answers as well as the corresponding contextual information. In example embodiments, attribute information (e.g., date information) may be used to chronologically order the QA trace records. The time-series of QA trace records may then be utilized for downstream analysis and visualization. For instance, in the context of an emerging disease searched against a scientific literature corpus, various visualization plots may be generated that illustrate how contextual information surrounding the study of the disease is evolving over time. These plots may illustrate, for example, changes in the frequency with which symptoms are mentioned in the literature over time (where such symptoms may be identified using NER processing); changes in the frequency of mentions of other disease-related terminology over time (e.g., incubation period); and so forth. Thus, such visualization plots may reveal patterns and trends in the evolution of the understanding and knowledge of an emerging disease over time, for example.

Another non-limiting example of a downstream analysis step that can utilize QA trace records is a Bayesian inference, which refers to a family of probabilistic methods for inferring new knowledge based on prior knowledge and a collection of newly observed facts. In the context of QA trace records relating to the study of a disease or a disease event, these probabilistic methods can determine a prior belief from previous diseases/disease events using earlier trace records, which may be conditioned by geographical location and/or by patient attributes (e.g., gender, age, etc.). This can then be used to update the posterior confidence of the extracted answers based on the corresponding prior or to identify a scenario deviation. In the case of identifying a scenario deviation, a Bayesian analysis using the other associated attributes could be utilized to characterize the deviation as a potential emerging disease scenario, for example.

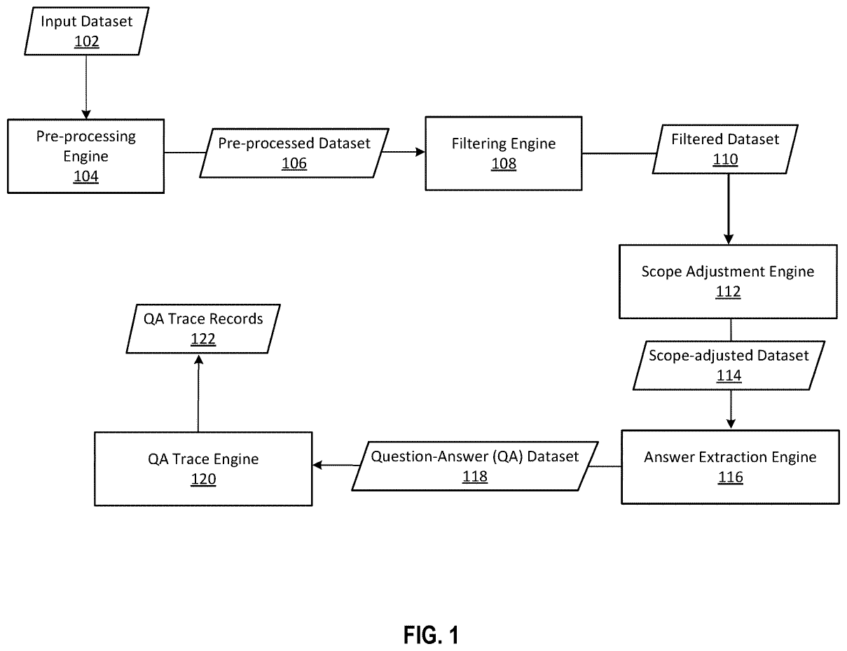

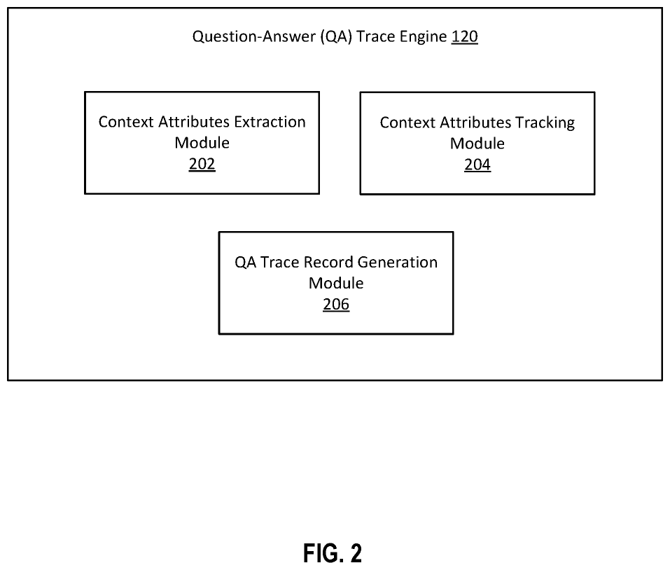

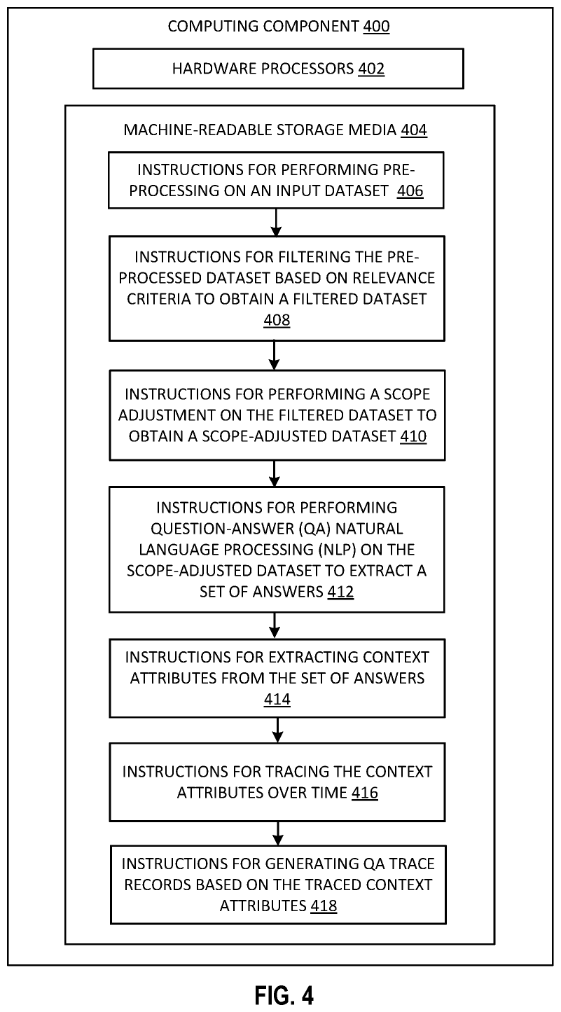

Referring now to illustrative embodiments of the invention, FIG. 1 depicts an example flowchart illustrating data flows between various computing engines as part of a QA trace record generation process. FIG. 2 depicts example processing modules of a particular computing engine (a QA trace engine) depicted in FIG. 1. FIG. 4 depicts a set of executable instructions stored in machine-readable storage media that, when executed, cause an illustrative method to be performed for generating QA trace records based on various stages of processing performed on an input dataset according to example embodiments of the invention. FIGS. 1, 2, and 4 will be described in conjunction with one another hereinafter.

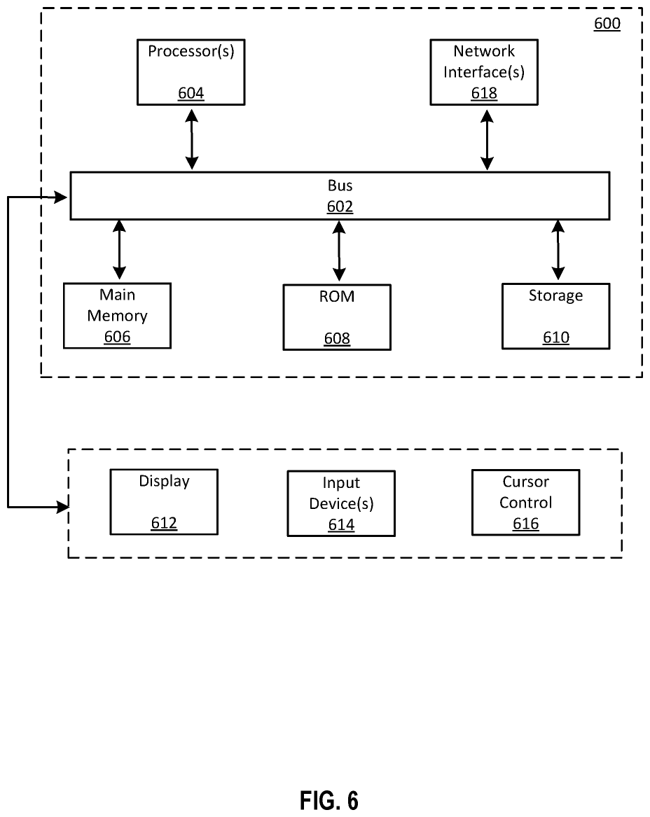

FIG. 4 depicts a computing component 400 that includes one or more hardware processors 402 and machine-readable storage media 404 storing a set of machine-readable/machine-executable instructions that, when executed, cause the hardware processors 402 to perform an illustrative QA trace record generation process according to example embodiments of the invention. The computing component 400 may be, for example, the computing system 600 depicted in FIG. 6, or another computing device described herein. In some embodiments, the computing component 400 may be an edge computing device such as a desktop computer; a laptop computer; a tablet computer/device; a smartphone; a personal digital assistant (PDA); a wearable computing device; a gaming console; another type of low-power edge device; or the like. In other example embodiments, the computing component 400 may be a server, a server cluster, or the like. The hardware processors 402 may include, for example, the processor(s) 604 depicted in FIG. 6 or any other processing unit described herein. The machine-readable storage media 404 may include the main memory 606, the read-only memory (ROM) 608, the storage 610, or any other suitable machine-readable storage media described herein.

In example embodiments, the instructions depicted in FIG. 4 as being stored on the machine-readable storage media 404 may be modularized into one or more computing engines such as those depicted in FIG. 1. In particular, each such computing engine may include a set of machine-readable and machine-executable instructions, that when executed by the hardware processors 402, cause the hardware processors 402 to perform corresponding tasks/processing. In example embodiments, the set of tasks performed responsive to execution of the set of instructions forming a particular computing engine may be a set of specialized/customized tasks for effectuating a particular type/scope of processing.

In example embodiments, the hardware processors 402 (or any other processing unit described herein) are configured to execute the various computing engines depicted in FIG. 1, which in turn, are configured to provide corresponding functionality in connection with QA trace record generation. In particular, the hardware processors 402 may be configured to execute a pre-processing engine 104, a filtering engine 108, a scope adjustment engine 112, an answer extraction engine 116, and a QA trace engine 120. These engines can be implemented as hardware or as a combination of hardware, software, and/or firmware. In some embodiments, one or more of these engines can be implemented, at least in part, as software and/or firmware modules that include computer-executable/machine-executable instructions that when executed by a processing circuit (e.g., the hardware processors 402) cause one or more operations to be performed. In some embodiments, these engines may be customized computer-executable logic implemented within a customized computing machine such as a customized field programmable gate array (FPGA) or an application specific integrated circuit (ASIC). A system or device described herein as being configured to implement example embodiments of the invention (e.g., the computing device 600) can include one or more processing circuits, each of which can include one or more processing units or cores. These processing circuit(s) (e.g., the hardware processors 402, processor(s) 604) may be configured to execute computer-executable code/instructions of these various engines to cause input data contained in or referenced by the computer-executable program code/instructions to be accessed and processed by the processing unit(s)/core(s) to yield output data. It should be appreciated that any description herein of an engine performing a function inherently encompasses the function being performed responsive to computer-executable/machine-executable instructions of the engine being executed by a processing circuit.

Referring now to FIG. 4 in conjunction with FIG. 1, at block 406, machine-executable instructions of the pre-processing engine 104 may be executed by the hardware processors 402 to cause pre-processing to be performed on an input dataset 102. The dataset 102 may include a text corpus such as a specialized, domain-specific text corpus of scientific literature. More generally, the input dataset 102 may include any type of structured or unstructured information relating to one or more knowledge domains including, without limitation, textual data, graphical data, image data, tabular data, or the like. In example embodiments, the pre-processing may include indexing, cleaning, and/or parsing data and/or metadata in the input dataset 102. The result of the pre-processing performed at block 406 may be a pre-processed dataset 106.

Then, at block 408, machine-executable instructions of the filtering engine 108 may be executed by the hardware processors 402 to cause the pre-processed dataset 106 to be filtered based on relevance criteria to obtain a filtered dataset 110. For instance, in example embodiments, the filtering engine 108 may filter the pre-processed dataset 106 to contract the scope of the passages against which natural language questions will be posed to those that are relevant to a generalized topic to which the questions relate (e.g., the study of a particular disease in humans). The filtering engine 108 may further filter the pre-processed dataset 106 based on other relevance criteria including, for example, a date range to be searched, a subset of publication sources (e.g., a subset of scholarly journals) to be searched, publications authored by a particular author, and so forth. In some example embodiments, the relevance criteria may be used to establish a confidence threshold, which may be a numerical score or a range of values that is generated by taking into account (and potentially weighting) each factor that is assessed as part of the relevance criteria.

At block 410, machine-executable instructions of the scope adjustment engine 112 may be executed by the hardware processors 402 to cause a scope adjustment to be performed on the filtered dataset 110. In some example embodiments, the instructions at block 412 may be executed to cause NLP to be performed on a posed natural language question with respect to the filtered dataset 110 to extract a set of answers from the filtered dataset 110 that are determined to be relevant to the posed question. A QA system pipeline that combines, for example, information retrieval and neural language models may be used to extract the set of answers. In example embodiments, machine-executable instructions of the scope adjustment engine 112 may then be executed by the hardware processors 402 to cause a scope adjustment to be performed to increase the size of the answer set beyond the set of answers that is initially extracted. For instance, while the initial scope of documents searched may be filtered/contracted to those documents that are deemed relevant to a broad topic to which the posed natural language question relates (e.g., an emerging disease in humans), and ultimately to passages that are relevant to the posed question, the scope may subsequently be expanded to more passages on related material (e.g., other passages in a same technical paper or related concepts) in order to gather additional context and generate additional QA trace records. As an illustrative example, a natural language question asking about symptoms relating to a particular disease (disease X) may be posed against a text corpus. After extracting portions of the text corpus that include answers deemed relevant to the question that was posed regarding disease X, the scope adjustment engine 112 may perform a scope adjustment to include other portions of the text corpus beyond just the extracted portions. For example, the scope adjustment engine 112 may expand the scope to other passages in a same technical paper, passages in another technical paper that is cited in the paper from which passages were extracted, and so forth. This expansion in the scope of text that is analyzed may reveal additional answers and/or contextual information that is relevant to the natural language question that was originally posed. For instance, the scope expansion may identify another disease (Disease Y) that exhibits similar symptoms to Disease X, but with certain key differences in incubation period, onset of symptoms, severity of symptoms, or the like that reveal deeper insights into Disease X.

As a result of the scope adjustment performed at block 410, a scope-adjusted dataset 114 may be obtained. As previously noted, the scope-adjusted dataset 114 may represent an expansion of the filtered dataset 110 to include additional portions of the pre-processed dataset 106 that may not have satisfied the initial relevance criteria that was evaluated to obtain the filtered dataset 110, but which may nonetheless be relevant for gathering additional contextual information for subsequent generation of QA trace records. Subsequent to performing the scope adjustment, machine-executable instructions of the answer extraction engine 116 may be executed by the hardware processors 402 at block 412 to cause QA NLP to be performed on the scope-adjusted dataset 114 to extract a set of answers 118 associated with a natural language question that is posed against the scope-adjusted dataset 114. In addition, at block 412, the answer extraction engine 116 may filter the extracted set of answers 118 to exclude those answers that do not meet a confidence threshold, which as noted earlier, may be determined based on the relevance criteria used to obtain the filtered dataset 110. In some example embodiments, the instructions at block 410 and the instructions at block 412 may be iteratively executed two or more times in order to expand the QA dataset 118 and/or increase the relevancy of the QA dataset 118 to the posed natural language question as well as to obtain traces of the answers over time. Thus, the QA dataset 118 may include a series of answers to the posed natural language question extracted from the scope-adjusted dataset 114 over time.

At block 414, machine-executable instructions of the QA trace engine 120 may be executed by the hardware processors 402 to cause context attributes to be extracted from passages corresponding to answers in the QA dataset 118. More specifically, referring now to FIG. 2, the QA trace engine 120 may include various program modules configured to perform specialized tasks in connection with extraction of the contextual information and the use of the contextual information to generate QA trace records. In particular, the QA trace engine 120 may include a context attributes extraction module 202, a context attributes tracking module 204, and a QA trace record generation module 206. In example embodiments, machine-executable instructions of the context attributes extraction module 202 may be executed by the hardware processors 402 to cause contextual information including various context attributes relating to answers in the QA dataset 118 to be extracted.

The extracted context attributes may include, for example, various attribute information relating to extracted answers including, for example, a date attribute identifying a time period to which the answer is contextually linked, a domain-specific attribute (e.g., a particular study methodology chosen for a scientific study, a particular term or phrase relevant to the contextually-linked answer, etc.), and so forth. In some example embodiments, extracting the context attributes may include posing one or more additional natural language questions that relate to specific details associated with an answer. Such additional context-specific natural language questions may be posed against the scope-adjusted dataset 114, for example. Answers to these additional, answer-specific questions may then form at least part of the extracted contextual information. In addition, domain-specific NER or relationship extraction processing may be performed on passages corresponding to extracted answers to mine and extract domain-specific concepts from the passages as contextual information. For instance, in the case of a scientific literature corpus and QA processing relating to a particular disease being studied, the NER processing may utilize various scientific biomedical entity recognition models that search the extracted passages for particular disease terms, chemical terms, gene terms, organ names, or the like. As another non-limiting example, a clinical context recognition model such as a PICO model may be employed.

In example embodiments, machine-executable instructions of the context attributes tracking module 204 may be executed by the hardware processors 402 to cause the extracted context attributes to be tracked over a period of time along with the corresponding time-series of answers in the QA dataset 118. Tracking of contextual information related to answers may reveal trends/patterns based on how the contextual information evolves over time. For instance, in the example use case involving an emerging disease, the terminology used in a domain-specific corpus (e.g., scholarly papers, medical studies, etc.) to characterize/describe symptoms and/or treatments for the disease may change over time as more knowledge of the disease is obtained. By tracking, over time, contextual attributes such as disease-related terminology using, for example, NER processing, a more accurate understanding of the disease and the evolution of medical knowledge surrounding how the disease is transmitted, what the disease symptoms are, and what treatments are successful against the disease can be obtained. It should be appreciated that the example of an emerging disease and QA processing performed with respect to a medical literature corpus is merely illustrative and that example embodiments of the invention are applicable to any scenario in which natural language questions are posed against a domain-specific corpus that may evolve over time.

In example embodiments, machine-executable instructions of the context QA trace record generation module 206 may be executed by the hardware processors 402 to cause a set of QA trace records to be generated based on the traced context attributes and the corresponding traced answers. In example embodiments, the set of QA trace records may be chronologically ordered to reflect the evolution over time in the answers and the corresponding contextual information contained therein. In example embodiments, attribute information (e.g., date information) may be used to chronologically order the QA trace records. Each QA trace record may represent a snapshot at a given point in time of one or more answers identified in response to one or more posed natural language questions and corresponding contextual information associated with the identified answer.

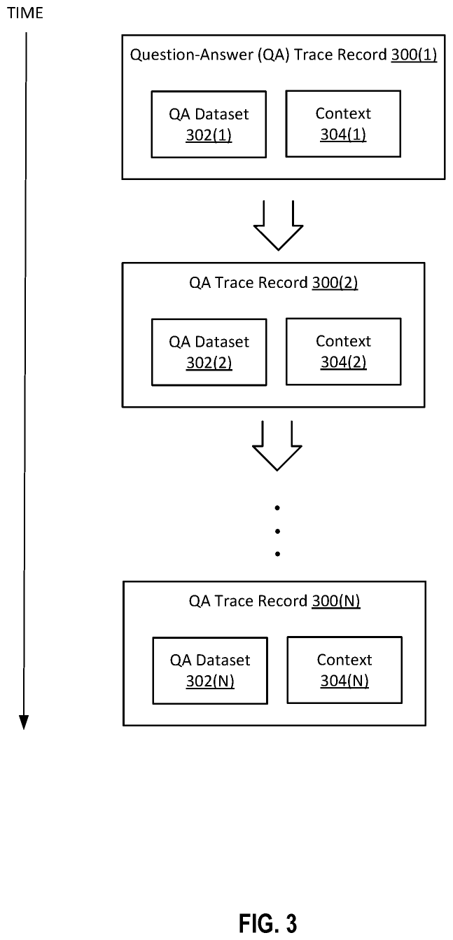

FIG. 3 depicts an example series of QA trace records 300(1)-300(N) generated over time, where N is any integer greater than 1. The series of QA trace records includes corresponding respective QA datasets 302(1)-302(N) as well as corresponding respective contextual information 304(1)-304(N). More specifically, in some example embodiments, each QA trace record in the series of QA trace records 300(1)-300(N) may correspond to a snapshot of answers in the QA dataset 118 that correspond to a particular natural language question at a given point in time and a snapshot of corresponding contextual information at that point in time. Thus, the time-series of QA trace records 300(1)-300(N) may include a trace, over time, of answers to a posed natural language question (e.g., QA datasets 302(1)-302(N)) as well as a trace, over time, of contextual information 304(1)-304(N) that corresponds to the traced answers. The contextual information 304(1)-304(N) may reflect varied contextual attributes and/or the evolution of context over time as it pertains to the evolving answers to the particular natural language question.

Assume, for example, the following natural language question: “what are the most prevalent symptoms of disease X?” The answers to this question (e.g., which symptoms are most prevalent) may evolve over time as new studies are performed and new data is gathered, and the contextual information 304(1)-304(N) may provide insight into why the answers evolved. For instance, a particular symptom (e.g., loss of taste/smell) may not have been apparent in the early transmission stage of a disease, but may later be identified as a frequent symptom as more cases/studies/data emerges. The contextual information 304(1)-304(N), and in particular, the evolution of that contextual information over time may reveal when and what (e.g., particular clinical studies) caused the shift in understanding in terms of the symptoms identified as being most closely associated with the disease being investigated.

In some example embodiments, each of the QA datasets 302(1)-302(N) included in the QA trace records 300(1)-300(N) may include a collection of multiple answers extracted in response to multiple natural language questions. In some example embodiments, each QA dataset (referred to herein generically as QA dataset 302) includes answers (or some subset thereof) extracted at a given point in time in response to multiple posed natural language questions. In such example embodiments, the corresponding contextual information 304(1)-304(N) may reflect different context surrounding the various extracted answers, which in turn, may be used to evaluate the relative strength/relevancy of the answers with respect to each other. Moreover, the time-series nature of the QA trace records 300(1)-300(N) may further facilitate evaluating the relative strength/accuracy/relevancy of the answers and the corresponding contextual information 304(1)-304(N) as they evolve over time, potentially revealing an answer to be less accurate or relevant as it was initially assumed to be.

In example embodiments, the extracted answers (QA datasets 302(1)-302(N)) and the corresponding contextual information (304(1)-304(N)) may exhibit a significant amount of variation in wording. For instance, certain answers and/or contextual information may utilize varied phraseology, but may actually convey the same or similar meaning. As such, in some example embodiments, post-processing such as distillation and aggregation may be performed to prioritize more relevant context prior to generating and populating the QA trace records 300(1)-300(N).

In example embodiments, the time-series of QA trace records 300(1)-300(N) may then be utilized for downstream analysis and visualization. For instance, in the context of an emerging disease searched against a scientific literature corpus, various visualization plots may be generated that illustrate how contextual information surrounding the study of the disease is evolving over time. These plots may illustrate, for example, changes in the frequency with which symptoms are mentioned in the literature over time (where such symptoms may be identified using NER processing); changes in the frequency of mentions of other disease-related terminology over time (e.g., incubation period); and so forth. Thus, such visualization plots may reveal patterns and trends in the evolution of the understanding and knowledge of an emerging disease over time, for example.

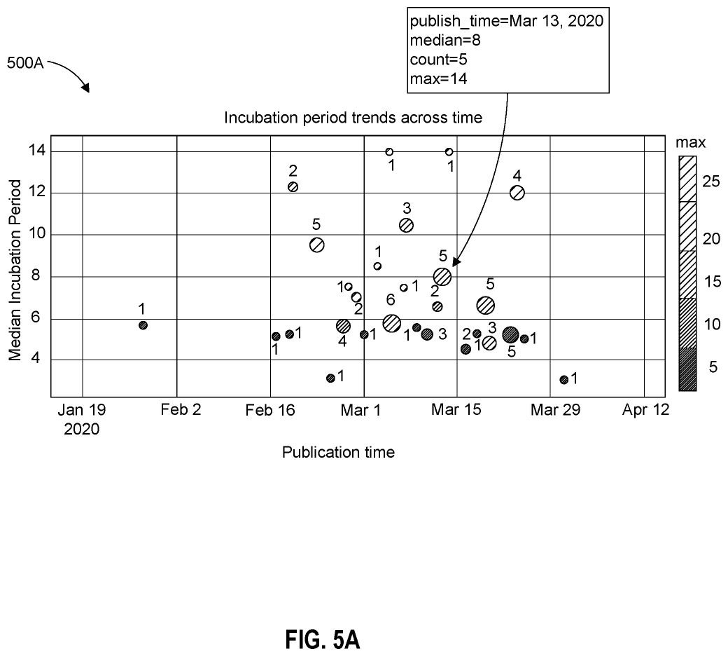

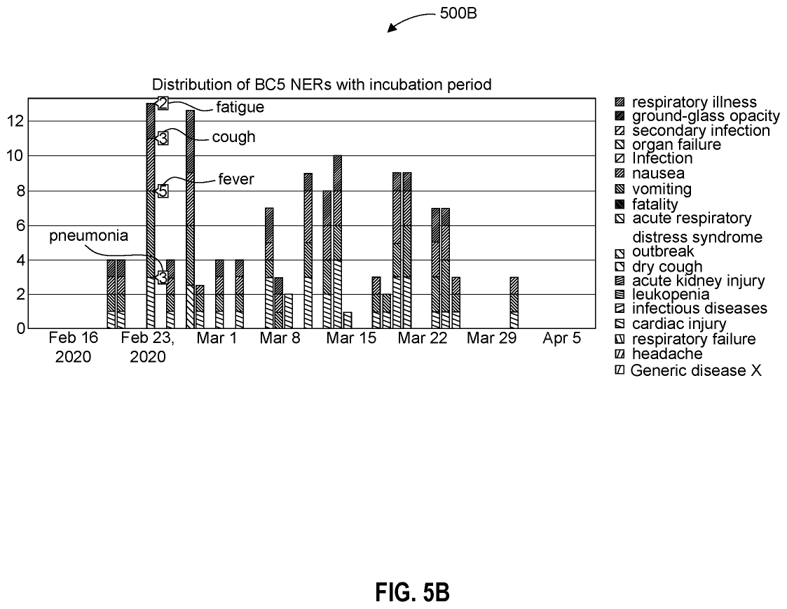

In certain example embodiments, a visualization plot may be presented via a user interface (UI) such as a graphical user interface (GUI). FIGS. 5A and 5B depict example visualization plots that may be generated based on a time-series of QA trace records and then presented via a GUI. The visualization plot 500 depicted in FIG. 5A provides a visual indication of various incubation periods for a particular emerging disease that are mentioned within a text corpus (e.g., within published clinical studies/articles) overtime. The incubation period identified for the disease may change over time as new data/studies become available. For instance, as shown in the example visualization plot 500, in the early stages of disease transmission—when very little may be known about how the disease is transmitted and what symptoms it presents with—the mentions of incubation period for the disease in the medical literature may be sparse. However, as depicted in FIG. 5A, as time progresses and more information is gathered about the disease, the number of mentions of incubation period dramatically rises. Another trend revealed by the visualization plot 500 is how the mentions of incubation period coalesce to a fairly well-defined range over time (e.g., between 5-8 days). This also reveals how a more precise understanding of an aspect of the disease (e.g., incubation period) can be obtained over time as a greater understanding of the disease is developed. A time-series of QA trace records, where each record identifies, for example, an incubation period of the disease mentioned in the medical literature for a particular time period may be used to generate the example visualization plot 500, which provides a visual indication of how scientific understanding regarding the incubation period changes and becomes more certain over time.

FIG. 5B depicts another example visualization plot 500B that can be generated based on a time-series of QA trace records. The example visualization plot 500B illustrates the distribution of symptom types over time in relation to the incubation periods visualized in plot 500A. As QA trace records are generated that include various terms representing symptom types, where such terms may be extracted using, for example, NER processing, the information contained in such QA trace records can be combined with the incubation period information visualized in plot 500A to generate the plot 500B. Thus, plot 500B illustrates how different sets of time-series QA trace records can be aggregated/combined to generate visualization plots that contain an enhanced amount of information. In particular, plot 500B illustrates which symptom types are mentioned at various points in time in connection with different stages of the incubation period identified for the disease at those points in time. As such, plot 500B provides insight into how the onset of symptoms evolves over time as the understanding of the incubation period evolves over time.

The GUI may be user-manipulatable and may include various UI elements capable of being selected and/or manipulated by a user to modify the presentation of data in the visualization plot. For instance, the time period over which the QA trace records are visualized may be adjustable. In some example embodiments, certain contextual information may be emphasized over other contextual information. For instance, the GUI may be manipulatable to emphasize a set of answers to a particular natural language question (e.g., what are the most prevalent symptoms of disease X?) as well as the corresponding contextual attributes associated with those answers over time. In some example embodiments, the GUI may dynamically change in real-time. For instance, a visualization plot presented in the GUI may include answers and contextual attributes traced over a first period of time. Then, as additional answers and contextual attributes are identified and extracted over a second period of time, the GUI may dynamically change to reflect these changes.

Another non-limiting example of a downstream analysis step that can utilize QA trace records is a Bayesian inference, which refers to a family of probabilistic methods for inferring new knowledge based on prior knowledge and a collection of newly observed facts. In the context of QA trace records relating to the study of a disease or disease event, these probabilistic methods can determine a prior belief from previous diseases/disease events using earlier trace records, which may be conditioned by geographical location and/or by patient attributes (e.g., gender, age, etc.). This can then be used to update the posterior confidence of the extracted answers based on the corresponding prior or to identify a scenario deviation. In the case of identifying a scenario deviation, a Bayesian analysis using the other associated attributes could be utilized to characterize the deviation as a potential emerging disease scenario, for example.

Another potential use case in which QA trace records generated according to example embodiments of the invention may find applicability is in the context of fake news detection. As used herein, fake news may refer to any information that is propagated to a public audience through one or more distribution channels, and which includes false or misleading content that is presented as factual information relating to topics considered to be newsworthy. Detecting fake news often relies on spotting deviations in consistency as seen in connection with viral patterns of spread. In particular, the more dramatic the news, the faster it may propagate, and the more likely it may be to amplify misinformation. In recent years, more and more people are obtaining their news from online social media platforms rather than traditional media sources such as television and newspapers. These online platforms, however, tend to publish unvalidated real-time content from diverse and often adversarial sources. Extracting QA traces in accordance with example embodiments of the invention from diverse information sources, such as those that publish across various social media platforms, may provide a means to automatically analyze patterns and trends and may enhance the frequency and accuracy of fake news detection.

Another example use case in which QA trace records generated according to example embodiments of the invention may find applicability is in connection with product support. For instance, identifying quality issues subsequent to rollout of new products in the field could be made easier by generating QA trace records from incoming support case information. In particular, techniques according to example embodiments of the invention may be employed to process incoming case data in order to better understand the areas where the support cases are predominantly being reported. As the usage of the product matures in the field, the possibility of more reported issues relating to newer functional areas of the product increases. As such, generation of QA trace records over time may help reveal any functional areas of the product that potentially show signs of instability over time as the product handles more and more workloads.

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms such as machine-readable storage media, as used herein, refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicate with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method, comprising:
performing question-answer (QA) processing on a dataset, the QA processing comprising identifying and extracting portions of the dataset that correspond to a set of answers to a natural language question posed with respect to the dataset;
extracting context attributes from the extracted portions of the dataset corresponding to the set of answers;
tracing the set of answers and the context attributes over a period of time; and
generating a set of QA trace records based at least in part on traced set of answers and the traced context attributes, wherein each QA trace record corresponds to a respective answer in the set of answers and comprises a respective subset of the extracted context attributes.

2. The computer-implemented method of claim 2, further comprising:
filtering a scope of an input text corpus based at least in part on one or more relevance criteria to obtain a filtered text corpus; and
performing a scope adjustment on the filtered text corpus to obtain the dataset.

3. The computer-implemented method of claim 2, wherein performing the scope adjustment comprises at least one of contracting a scope of the filtered text corpus or expanding a scope of the filtered text corpus.

4. The computer-implemented method of claim 1, wherein the set of answers is a second set of answers, and wherein performing the QA processing on the dataset comprises:
determining that a first set of answers from the dataset that satisfy baseline criteria for being responsive to the natural language question; and
filtering the first set of answers to obtain the second set of answers, wherein the filtering comprises excluding, from the first set of answers, each answer that does not meet a confidence threshold.

5. The computer-implemented method of claim 1, wherein extracting the context attributes from the extracted portions of the dataset that correspond to the set of answers comprises performing named entity recognition processing on the extracted portions of the dataset.

6. The computer-implemented method of claim 5, wherein performing the named entity recognition processing on the extracted portions of the dataset comprises:
identifying one or more domain-specific concepts from the extracted portions of the dataset; and
extracting the one or more domain-specific concepts as at least a portion of the context attributes.

7. The computer-implemented method of claim 1, wherein the natural language question is a first natural language question and the set of answers is a first set of answers, and wherein extracting the context attributes comprises:
determining a second natural language question having a narrower scope of candidate answer types than the first natural language question; and
performing the QA processing on the extracted portions of the dataset to determine a second set of answers to the second natural language question, wherein the extracted context attributes comprise the second set of answers.

8. The computer-implemented method of claim 1, wherein performing the QA processing comprises:
receiving the natural language question as input;
determining a question type of the natural language question;
determining an answer type that corresponds to the determined question type; and
executing an information retrieval process on the dataset, wherein executing the information retrieval process comprises:
identifying the portions of the dataset that correspond to the set of answers for the natural language question by determining that each of the portions of the dataset includes a respective one or more keywords associated with the answer type; and
extracting the identified portions of the dataset.

9. The computer-implemented method of claim 1, wherein each respective subset of the extracted context attributes comprises a respective date attribute associated with the respective answer, the method further comprising:
ordering the set of QA trace records based at least in part on each respective date attribute.

10. The computer-implemented method of claim 1, further comprising:
generating an interface comprising one or more visualizations of the set of QA trace records; and
presenting the interface via an output device.

11. The computer-implemented method of claim 10, wherein the period of time is a first period of time, the method further comprising:
tracing the extracted set of answers and the extracted context attributes over a second period of time subsequent to the first period of time;
expanding the set of QA trace records based at least in part on the extracted set of answers and the extracted context attributes traced over the second period of time; and
modifying the user interface to dynamically update the one or more visualizations as the set of QA trace records is expanded.

12. A system, comprising:
a memory storing machine-executable instructions; and
a processor configured to access the memory and execute the machine-executable instructions to:
perform question-answer (QA) processing on a dataset, the QA processing comprising identifying and extracting portions of the dataset that correspond to a set of answers identified over a period of time to a natural language question posed with respect to the dataset;
extract, over the period of time, context attributes from the extracted portions of the dataset corresponding to the set of answers; and
generating a time series of QA trace records based at least in part on the extracted set of answers and the extracted context attributes, wherein each QA trace record corresponds to a respective answer in the set of answers and comprises a respective subset of the extracted context attributes.

13. The system of claim 12, wherein the extracted context attributes comprise a respective date attribute associated with each answer, and wherein the respective date attributes determine an ordering of the time series of QA trace records.

14. The system of claim 12, wherein the at least one processor is further configured to execute the machine-executable instructions to:
filter a scope of an input text corpus based at least in part on one or more relevance criteria to obtain a filtered text corpus; and
perform a scope adjustment on the filtered text corpus to obtain the dataset.

15. The system of claim 14, wherein the at least one processor is configured to perform the scope adjustment by executing the machine-executable instructions to at least one of contract a scope of the filtered text corpus or expand a scope of the filtered text corpus.

16. The system of claim 12, wherein the at least one processor is configured to extract the context attributes from the extracted portions of the dataset that correspond to the set of answers by executing the machine-executable instructions to perform named entity recognition processing on the extracted portions of the dataset.

17. The system of claim 16, wherein the at least one processor is configured to perform the named entity recognition processing on the extracted portions of the dataset by executing the machine-executable instructions to:
identify one or more domain-specific concepts from the extracted portions of the dataset; and
extract the one or more domain-specific concepts as at least a portion of the context attributes.

18. The system of claim 12, wherein the natural language question is a first natural language question and the set of answers is a first set of answers, and wherein the at least one processor is configured to extract the context attributes by executing the machine-executable instructions to:
determine a second natural language question having a narrower scope of candidate answer types than the first natural language question; and
perform the QA processing on the extracted portions of the dataset to determine a second set of answers to the second natural language question, wherein the extracted context attributes comprise the second set of answers.

19. A computer program product comprising a non-transitory computer readable medium storing program instructions that, when executed by a processor, cause operations to be performed comprising:
performing natural language processing on a dataset, the natural language processing comprising identifying and extracting portions of the dataset that correspond to a set of answers to a natural language question posed with respect to the dataset;
extracting context attributes from the extracted portions of the dataset corresponding to the set of answers;
tracing the set of answers and the context attributes over a period of time; and
generating a set of trace records based at least in part on the traced set of answers and the traced context attributes, wherein each trace record corresponds to a respective answer in the set of answers and comprises a respective subset of the extracted context attributes.

20. The computer program product of claim 19, wherein the period of time is a first period of time, the operations further comprising:
generating an interface comprising one or more visualizations of the set of trace records;
presenting the interface via an output device;
tracing the extracted context attributes over a second period of time subsequent to the first period of time;
expanding the set of trace records based at least in part on the tracing the extracted context attributes over the second period of time; and
modifying the user interface to dynamically update the one or more visualizations as the set of trace records is expanded.
